(19) United States
(12) Patent Application Publication
(10) Pub. No.: US 2022/0195974 A1
(43) Pub. Date: Jun. 23, 2022

(54) ENERGY GENERATION AND WATER REGULATION BY DRAINAGE INTO AQUIFERS

(71) Applicant: William Riley, Captica, FL (US)

(72) Inventor: William Riley, Captica, FL (US)

(21) Appl. No.: 17/131,229

(22) Filed: Dec. 22, 2020

(51) Int. Cl. F03B 13/06; F03B 13/08

(52) U.S. Cl. CPC F03B 13/06; F05B 2220/602; F03B 13/08

(57) ABSTRACT

An energy generation system includes an excess water drain disposed at a first elevation, an aquifer disposed at a second elevation lower than the first elevation, a conduit in fluid communication with the excess water drain and the aquifer, and a turbine generator disposed in the conduit. The turbine generator is configured to convert kinetic energy of excess water flowing through the conduit from the excess water drain to the aquifer into electrical energy.

### FIELD OF THE DISCLOSURE

The present disclosure relates to electrical energy generation systems including flow of excess water to aquifers.

### BACKGROUND

Excess water can accumulate in various types of water systems. Excess water in an ecosystem can lead to pollution of the ecosystem due to contaminants in the water. Excess water in water bodies (e.g., lakes or rivers) can flood and cause both environmental and economic damage.

An aquifer is an underground layer of water-bearing permeable rock, rock fractures, and/or unconsolidated materials (e.g., gravel, sand, or silt) from which groundwater can be extracted.

### SUMMARY

In one aspect, the present disclosure describes energy generations. For example, in some implementations the disclosure describes energy generation systems including an excess water drain disposed at a first elevation, an aquifer disposed at a second elevation lower than the first elevation, a conduit in fluid communication with the excess water drain and the aquifer, and a turbine generator disposed in the conduit. The turbine generator is configured to convert kinetic energy of excess water flowing through the conduit from the excess water drain to the aquifer into electrical energy.

Implementations of this or other systems may have one or more of the following characteristics. The excess water drain is disposed in a first ecosystem, and the first elevation is higher than a predetermined standard water level for the first ecosystem. The system includes a levee separating the excess water drain from a body of water. The system includes a water intake control system configured to controllably adjust water flow into the excess water drain. The water intake control system includes a dam separating the excess water drain from a body of water. The dam includes a gate adjustable between a first configuration and a second configuration, the first configuration blocks water from the body of water from flowing into the excess water drain, and the second configuration allows the water from the body of water to flow into the excess water drain. The excess water drain is disposed under a body of water, the water intake control system includes a gate adjustable between a first configuration and a second configuration, the first configuration blocks water from the body of water from flowing into the excess water drain, and the second configuration allows the water from the body of water to flow into the excess water drain. The water intake control system includes a local sensor arranged to measure an amount of excess water, and the water intake control system is configured to controllably adjust the water flow based on measurements from the local sensor. The system includes a central control system configured to perform operations including receiving macroscopic environment data of an ecosystem, and, based on the macroscopic environment data, transmitting control signals to a plurality of water intake control systems disposed in the ecosystem, including the water intake control system. The system includes a filtration system disposed in the conduit, the filtration system being configured to filter one or more pollutants out of the excess water. Thee filtration system is powered, at least in part, by the electrical energy. The conduit includes a pipe encasing a wellbore.

This disclosure also describes methods. For example, in some implementations this disclosures describes methods including collecting excess water in an excess water drain, directing the excess water to an aquifer, and converting kinetic energy associated with the excess water as the excess water is directed to the aquifer into electrical energy.

Implementations of this or other methods may have one or more of the following characteristics. The method includes adjusting a configuration of a dam from a first configuration to a second configuration. The first configuration blocks the excess water from flowing into the excess water drain, and the second configuration allows the excess water to flow into the excess water drain. The excess water drain is disposed under a body of water, and the method includes adjusting a configuration of a gate from a first configuration to a second configuration. The first configuration blocks water from the body of water from flowing into the excess water drain, and the second configuration allows the water from the body of water to flow into the excess water drain. The method includes filtering pollutants out of the excess water subsequent to collecting the excess water in the excess water drain. Filtering the pollutants out of the excess water includes filtering the pollutants using a water filtration system powered at least partially by the electrical energy. Directing the excess water to the aquifer includes directing the excess water through a conduit in fluid communication with the excess water drain and the aquifer. Converting the kinetic energy associated with the excess water as the excess water is directed to the aquifer into electrical energy includes directing the excess water through a turbine generator disposed in the conduit. The excess water drain is disposed at a first elevation that is higher than a second elevation of the aquifer. Directing the excess water to the aquifer includes directing the excess water through a plurality of conduits in fluid communication with the excess water drain and the aquifer, and converting the kinetic energy associated with the excess water as the excess water is directed to the aquifer into electrical energy includes directing the excess water through a plurality of turbine generators disposed in the plurality of conduits

Embodiments of the subject matter described in this specification can be implemented to realize one or more of at least the following advantages. For example, in some implementations, energy can be generated with little or no corresponding pollution. In some cases, excess water in an ecosystem can be regulated efficiently. Also, in some instances, depleted aquifers can be replenished through a corresponding direction of excess water.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 is a schematic showing an example energy generation system.

FIG. 2 is a schematic showing an example energy generation system.

FIGS. 3A-3B are schematics showing an example environment and excess water drain.

FIGS. 4A-4B are schematics showing an example water intake control system.

FIGS. 5A-5B are schematics showing an example water intake control system.

FIG. 6 is a schematic showing an example water intake control system.

FIG. 7 is a schematic showing an example environment with regulated excess water.

FIG. 8 is a schematic showing an example energy generation system.

FIG. 9 is a schematic showing an example energy generation system.

FIG. 10 is a schematic showing an example energy generation system.

### DETAILED DESCRIPTION

Excess water in an ecosystem can have damaging effects on local wildlife. For example, excess water can disturb existing ecological balances, modify soil composition, and, in case of flood, directly harm animals caught in the flood zone. Excess water also can directly harm humans through flooding, crop destruction, and other processes.

Human-caused drainage and development, by removing natural water drainage systems, has contributed to excess water buildup. For example, partly because of nearby development, a seasonal excess of water in the Florida Everglades exceeds the natural absorption capacity of that ecosystem. This water, which is often polluted, therefore may serve as a source for the transfer of pollutants directly into the ecosystem.

Climate change is expected to worsen these and similar problems, with rising sea levels flooding coasts and contributing to excess water problems inland.

Aquifers represent a potential storage for excess water. Often buried deep beneath the surface, these water-bearing regions of earth can have immense spare capacity available to be filled by excess surface water, given sufficient means for the transfer of the water between them. Such transfer, which represents movement of water from a first elevation to a second, lower elevation, can simultaneously be exploited to generate hydroelectric power based on the movement of the water.

Based on these principles, the present disclosure describes energy generation systems. In some implementations, this disclosure describes energy generation systems that direct excess water to aquifers, thereby both generating electricity and removing the excess water from the surface.

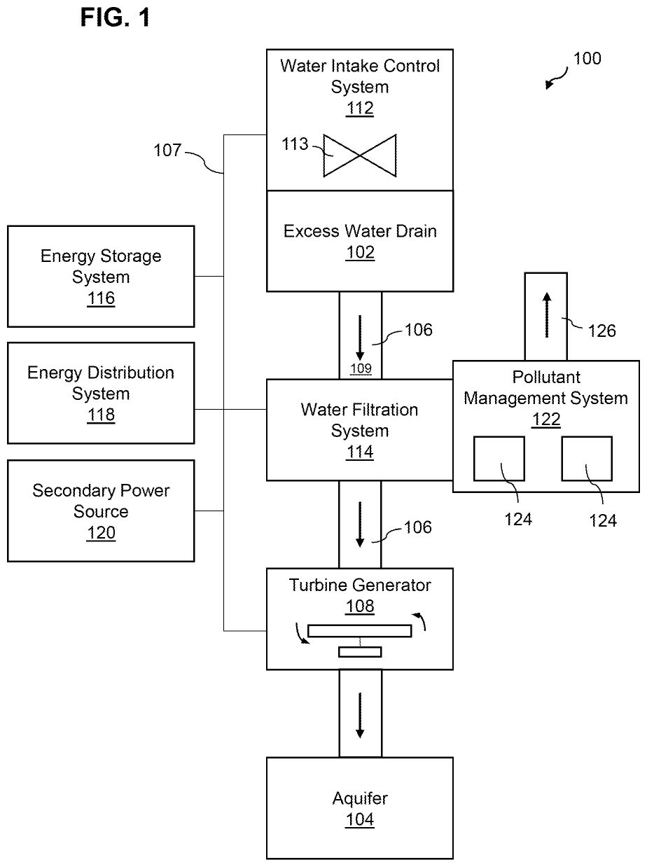

An example energy generation system 100 is shown schematically in FIG. 1A. The energy generation system 100 includes an excess water drain 102 and an aquifer 104. The excess water drain 102 and the aquifer 104 are in fluid communication with one another via a conduit 106 extending between them. The system 100 also includes a turbine generator 108 positioned in the fluid conduit 106.

As shown in FIG. 1A, during operation of the energy generation system 100, excess water from an excess water source 110 flows into the excess water drain 102. As the excess water flows through the conduit 106, kinetic energy from the flowing excess water is converted into electrical energy by the turbine generator 108.

The generated electrical energy can be utilized in various ways. In some implementations, at least a portion of the generated electrical energy can be relayed to a water intake control system 112, as described in further detail herein. In some implementations, at least a portion of the generated electrical energy can be relayed to a water filtration system 114, as described in further detail herein. In some implementations, at least a portion of the generated electrical energy can be relayed to an energy storage system 116 and stored for later use (e.g., by the water intake control system 112, the water filtration system 114, or other system near these systems). In some implementations, at least a portion of the generated electrical energy can be relayed to an energy distribution system 118, which in turn relays the generated electrical energy to one or more remote locations (e.g., to the power grid). In this manner, energy generated by the energy generation system 100 can be used to power the energy generation system 100 itself, power one or more facilities nearby the energy generation system 100, and/or power one or more facilities remote from the energy generation system 100.

Electrical conductors 107 (e.g., wires and/or cables) may electrically connect the turbine generator 108 to components to which it is coupled, e.g., the water intake control system 112, the water filtration system 114, the energy storage system 116, and/or the energy distribution system 118.

In some implementations, the energy generation system 100 can be powered partially or entirely by the electrical energy generated by the turbine generator 108. This case be useful, for example, as it enables the energy generation system 100 to eliminate or reduce its consumption of electrical power from outside sources. In some implementations, one or more components of the energy generation system 100 are partially or entirely powered by electrical energy generated by a secondary power source 120. In some implementations, the energy generation system 100 is unpowered, e.g., operates passively without requiring energy input.

The aquifer 104 is an underground layer of water-bearing permeable rock, rock fractures, and/or unconsolidated materials (e.g., gravel, sand, or silt) from which groundwater can be extracted. In some implementations, the aquifer 104 is a naturally occurring formation (e.g., a naturally occurring formation below the surface of the earth, with water naturally deposited in the formation).

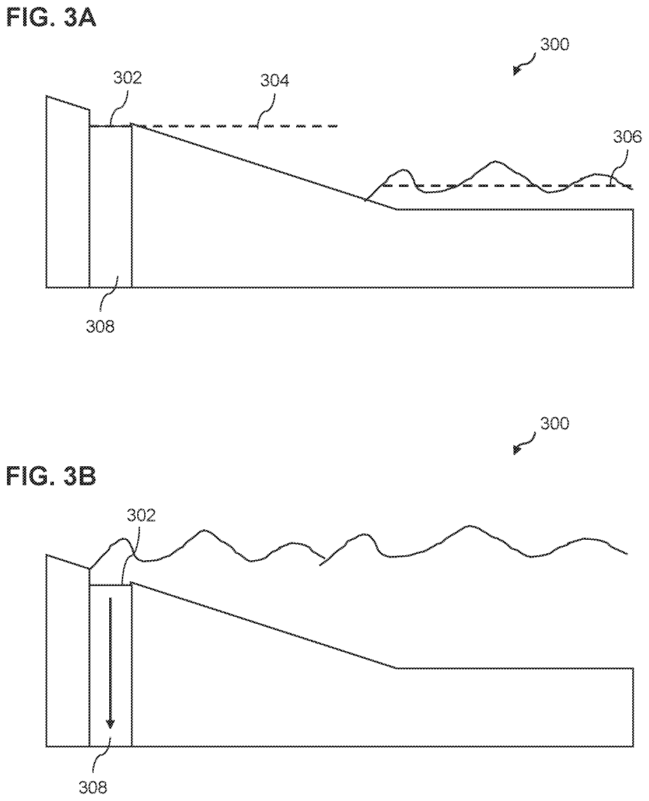

The water intake control system 112 includes one or more adjustable controls 113 operable to adjust a rate of flow of excess water into the excess water drain 102. The adjustable controls 113 may include, for example, pumps, valves, and/or gates. Examples of water intake control systems are described in more detail in reference to FIGS. 3-6. Some implementations of the water intake control system 112 are passive, e.g., do not include an adjustable control 113 but are rather configured inherently to adjust the rate of flow of excess water into the excess water drain 102 passively.

The water filtration system 114 may be integrated into the excess water drain 102 and/or disposed in the conduit 106. The water filtration system 114 is operable to remove pollutants from excess water flowing into the excess water drain 102 and through the conduit 106. The pollutants may include one or more of chemical agents, silt, debris, or sewage, among other possibilities.

In some implementations, the water filtration system 114 is passive, e.g., filters excess water using mechanical filtering, reverse osmosis filtering, or another method that may not be actively powered. In some implementations, the water filtration system 114 is active, which may include chemical treatment (e.g., chlorine treatment), backwashing, or another method that includes powered pumping or active treatment of the excess water. In some implementations, the water filtration 114 may include one or more temporary storage systems (e.g., storage tanks) in which excess water is treated before being directed further towards the aquifer 104. One or more valves may be operable to control the flow of water into, through, and/or out of the water filtration system. In some implementations, the water filtration system 114 includes both active and passive elements.

When the water filtration system 114 includes active elements, the active elements may be powered, for example, by electricity generated by the turbine generator 108.

In some implementations, the water filtration system 114 is connected to a pollutant management system 122. The pollutant management system 122 may include one or more storage tanks 124 that store pollutants removed from the excess water and/or one or more pollutant extraction conduits 126 configured to carry pollutants to the surface (e.g., driven by pumps), if the pollutant management system 122 is not disposed at the surface, or to another storage location.

Some implementations of the energy generation system 100 do not include a filtration system and/or pollutant management system. In such cases, the aquifer 104 may be a non-potable aquifer that is not used for drinking water.

As the excess water flows through the conduit 106, the turbine generator 108 converts at least a portion of the kinetic energy of the excess water into electrical energy. In some implementations, the turbine generator 108 includes one or more turbine and/or rotor assemblies 128 positioned in the path of the excess water flowing through the conduit 106. As the flowing water passes through the turbine generator 108, the flowing water rotates the turbine or rotor assemblies 128. This mechanical motion can be used to actuate one or more components 130 of a dynamo (e.g., a commutator) and/or an alternator (e.g., a magnet or an armature) to produce electrical current).

In some implementations, at least a portion of the generated electrical energy is related to an energy storage system 116 and stored for later use (e.g., by the water intake control system 112, water filtration system 114, and/or another system). The energy storage system 116 may include, for example, one or more mechanical energy storage devices (e.g., compressed air storage devices, hydraulic accumulators, etc.), electrical energy storage devices (e.g., capacitors), biological energy storage devices (e.g., glycogen storage devices), electrochemical energy storage devices (e.g., batteries, supercapacitors, etc.), thermal energy storage devices (e.g., molten salt energy storage devices, steam accumulators, etc.), and/or chemical energy storage devices (e.g., hydrogen energy storage devices, power-to-gas energy storage devices, etc.) to store electrical energy.

In some implementations, at least a portion of the generated electrical energy is relayed to an energy distribution system 118, which in turns relays the generated electrical energy to one or more remote locations. The energy distribution system 118 may include, for example, one or more electrical transformers to convert energy to a suitable current and voltage for transmission, and/or one or more electrical transmission lines to relay the electrical energy to a remote entity. In some implementations, the energy distribution system 118 is interconnected with a general power grid (e.g., a municipal or regional power grid) to supply electrical energy to one or more consumers (e.g., households, businesses, etc.) across a particular area.

In implementations that include a secondary power source 120, the secondary power source 120 provides electrical energy generated using one or more alternative sources of energy. For example, the secondary power source 120 may include one or more solar powered electrical generators, wind powered electrical generators, hydroelectric generators, tidal electrical generators, and/or steam generators. This may be useful, for example, because it allows the energy generation system 100 to operate in a more environmentally conscious manner. In some implementations, the secondary power source 120 generates electrical energy using other sources of energy, such as gasoline, oil, coal, nuclear fission, and so forth. In some implementation's, electrical energy from the secondary power source 120 is used to supplement the electrical energy generated by the turbine generator 108 to support operations of the energy generation system 100.

The conduit 106 is operable for conveying fluid from one location to another. In some implementations, the conduit 106 includes one or more pipes, tubes, and/or channels for carrying fluid. As an example, the conduit 106 may include one or more pipes encasing one or more wellbores extending between the excess water drain 102 and the aquifer 104.

Compared to some alternative sources of energy (e.g., fossil fuel sources), the energy systems described herein may, in some instances, produce fewer or essentially no pollutants, being based substantially on natural processes of excess water accumulation in ecosystems and gravitationally-powered flow of the excess water.

In addition, because of the large capacity of aquifers, significantly more water can be utilized than in alternative systems based on, for example, artificial underground tanks.

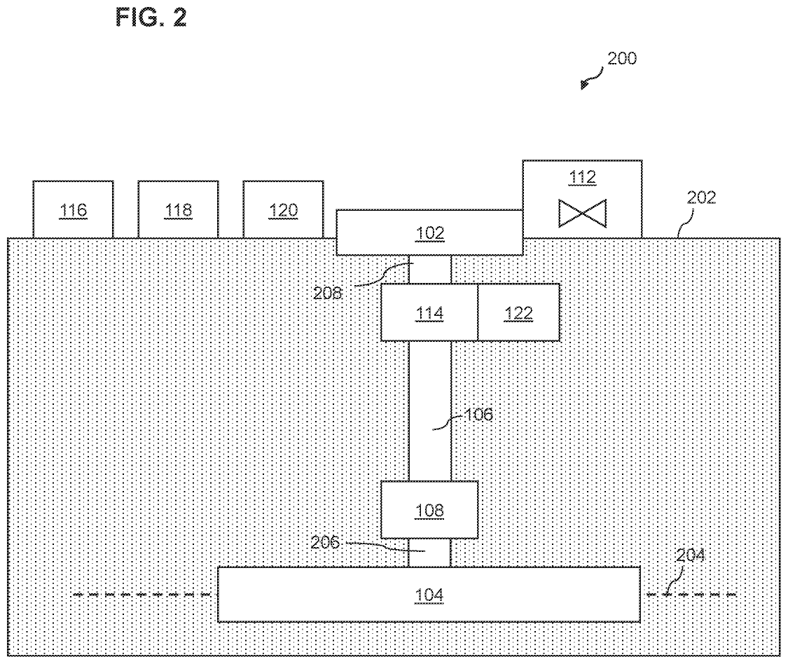

In some implementations, components of the energy generation system 100 may be disposed at particular elevations relative to one another to facilitate generation of electrical energy. For example, FIG. 2 shows an example energy generation system 200, in which components may operate similarly to components described in reference to FIG. 1. In this example, the excess water drain 102 is positioned at or near the earth's surface 202, and the aquifer 104 is positioned beneath the earth's surface 202 at a subterranean elevation 204. As the excess water drain 102 is at a higher elevation than the aquifer 104, excess water from the excess water drain 102 can flow to the aquifer 103 substantially under the influence of gravity. For example, once water has been directed into the water drain 102 or has flowed into the water drain 102, the water can flow down the conduit 106 and through the turbine generator 108 under the influence of gravity and without the aid of pumps. This can be useful, for example, as it reduces the amount of energy required to transfer the excess water from the excess water drain 102 to the aquifer 104. Furthermore, as water flows through the turbine generator 108 without the aid of pumps, the turbine generator 108 can produce electrical energy more efficiently.

In some implementations, the turbine generator 108 is disposed at or near a bottom end 206 of the conduit 106. This case be useful, for example, because it enables the excess water to acquire a relatively large amount of kinetic energy (e.g., due to its descent down the conduit 106), thereby increasing the amount of electrical energy that can be generated by the turbine generator 108.

In addition, in some implementations, the water filtration system 114 is disposed at or near a top end 208 of the conduit 106 (e.g., at or near the earth's surface 202), such that the water, which may lose some or all of its kinetic energy during the filtration process, is able to acquire a larger amount of kinetic energy after leaving the water filtration system 114 than if the water filtration system 114 were closer to the bottom end 206 of the conduit 106 and/or closer to the turbine generator 108.

In the example shown in FIG. 2, the water intake control system 112, energy storage system 116, energy distribution system 118, and secondary power source 120 are each positioned on the earth's surface 202. However, in practice one or more of these components can be positioned entirely or partially at different locations (e.g., beneath the earth's surface 202). Similarly, the water filtration system 114 is shown as positioned beneath the earth's surface 202; however, in some implementations the water filtration system 114 is on the earth's surface 202, e.g., directly at the excess water drain 102.

FIG. 3A shows an example of an ecosystem 300 in which an excess water drain 302 is disposed. The excess water drain 302 is disposed at a first elevation 304 that is higher than a second elevation 306 that is a standard water level for the ecosystem 300. The standard water level may be, for example, a standard water level of a body of water, a high-tide level at a coast, or another water level. The first elevation 304 may be, for example, an elevation that experiences water runoff flow during periods of excess water in the ecosystem 300.

Under normal conditions, negligible water flows into the excess water drain 302. However, as shown in FIG. 3B, when excess water accumulates in the ecosystem 300 (e.g., due to rain, flooding, environmental conditions, etc.), the water level rises to the first elevation 304 or higher, such that excess water flows into the excess water drain 302 and through a conduit 308, as described herein.

This arrangement of the excess water drain 302 as shown in FIGS. 3A-3B is a passive system that is at least partially self-regulating. That is, if a substantial amount of excess water is able to flow into the excess water drain 302 (and, in some implementations, other excess water drains that also take in excess water), then the water level in the ecosystem 300 can drop below the first elevation 304 because excess water is being drained, such that the flow of excess water is eventually cut off.

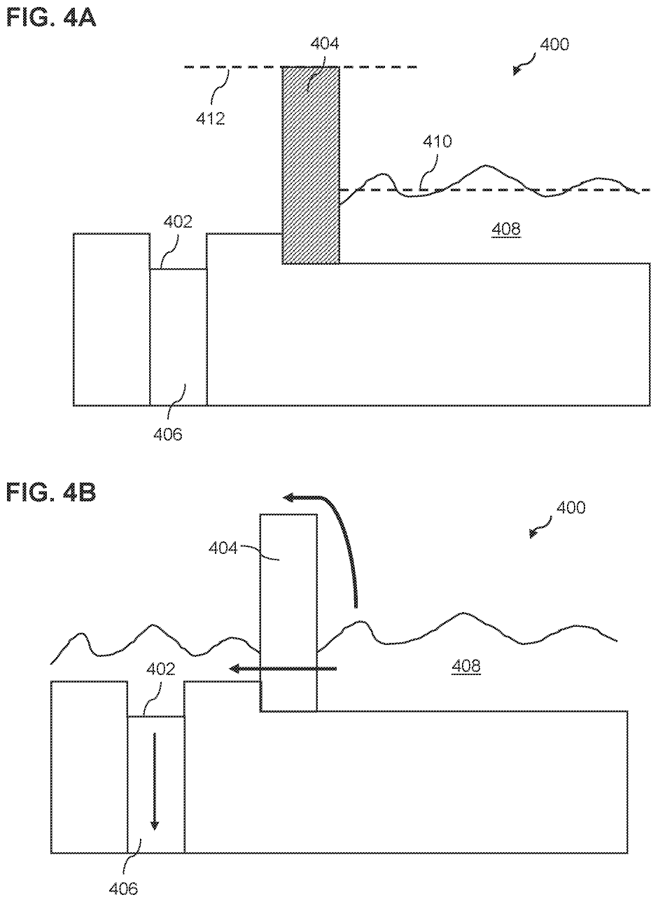

FIG. 4A shows another example of an ecosystem 400 in which an excess water drain 402 is disposed. In this example, a levee 404 is disposed between a body of water 408 and the excess water drain 402. The body of water 408, and bodies of water described throughout this disclosure, may be, for example, a river, a lake, an ocean, a marsh or wetland, a flood plain, etc.

Under typical conditions (e.g., without substantial excess water in the ecosystem 400), negligible water flows into the excess water drain 402. However, as shown in FIG. 4B, when water overcomes the levee 404 (by overtopping the levee 404 and/or by directly breaching the levee 404), excess water flows into the excess water drain 402 and through a conduit 406, as described herein.

The levee 404 forms a passive component of a water intake control system. A top elevation 412 of the levee 404 (e.g., higher than a standard water level 410 for the ecosystem 400) may be configured to regulate an amount of water in the ecosystem 400. For example, some amount of excess water over the standard water level 410 may be tolerated, but excess water that causes the water level to be higher than the levee 404 leads to excess water flow into the excess water drain 402.

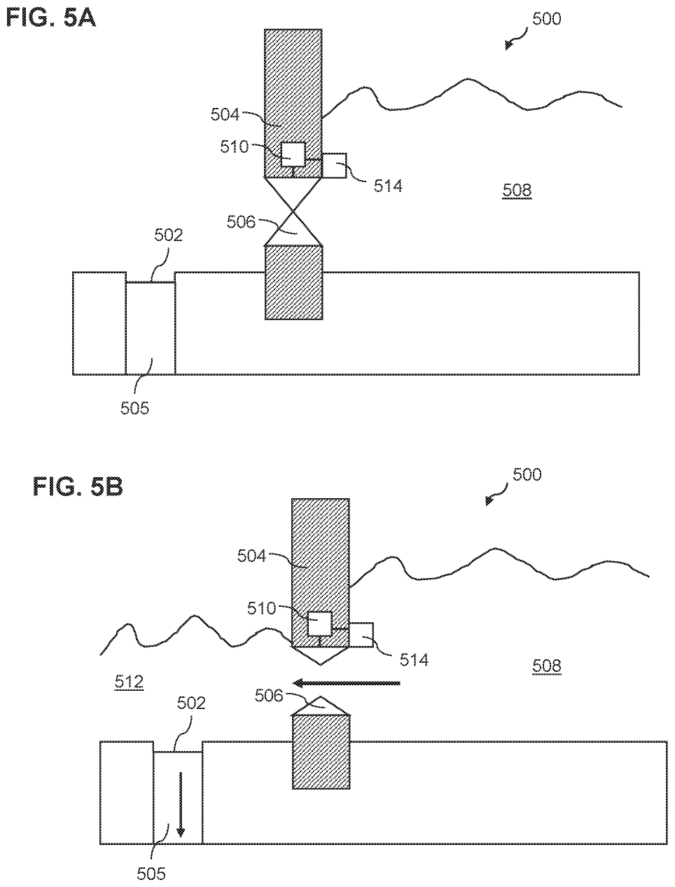

FIG. 5A shows another example of an ecosystem 500 in which an excess water drain 502 is disposed. In this example, a dam 504 separates a first body of water 508 (e.g., a body of water as described in reference to FIG. 4A) from the excess water drain 502. A gate 506 of the dam 504 is controlled by a control unit 510.

As shown in FIG. 5A, when the gate 506 is closed, water from the first body of water 508 is prevented from flowing into the excess water drain 502. However, as shown in FIG. 5B, when the control unit 510 opens the gate 506, water from the first body of water 508 is allowed to flow through the gate 506, into the excess water drain 502, and down a conduit 505. In some implementations, as shown in FIG. 5B, the gate 506 controls a level of water in a second water body 512 that feeds into the excess water drain 502 (e.g., is in direct fluidic communication with the excess water drain 502 even when the gate 506 is closed). A level of water in the second water body 512 at least partially determines the rate of excess water flow into the excess water drain 502.

The control unit 510 may be configured to control the gate 506 in various ways. For example, in some implementations, the control unit 510 receives signals from a local sensor 514 that is equipped to measure an amount of water in the ecosystem 500, e.g., a water level in the first body of water 508. The local sensor 514 may measure water level based on, for example, a pressure measurement or an optical measurement.

In some implementations, when the control unit 510 receives signals from the local sensor 514 that indicate an amount of excess water above a predetermined threshold, the control unit 510 causes the gate 506 to open, thereby regulating the amount of excess water in the environment 500. The control unit 510, the dam 504, and the local sensor 514 are included in a water intake control system of this system.

Other configurations for the control unit 510 and local sensor 514 are also possible. For example, in some implementations the gate 506 is controlled based on not only current excess water amounts but also historical excess water amounts, e.g., an average amount of excess water over a duration of time or a measured rate of change of excess water amount.

Although the local sensor 514 is shown as submerged under the first body of water 508, in some implementations one or more local sensors are located elsewhere in the ecosystem 500, e.g., on land near the body of water 508.

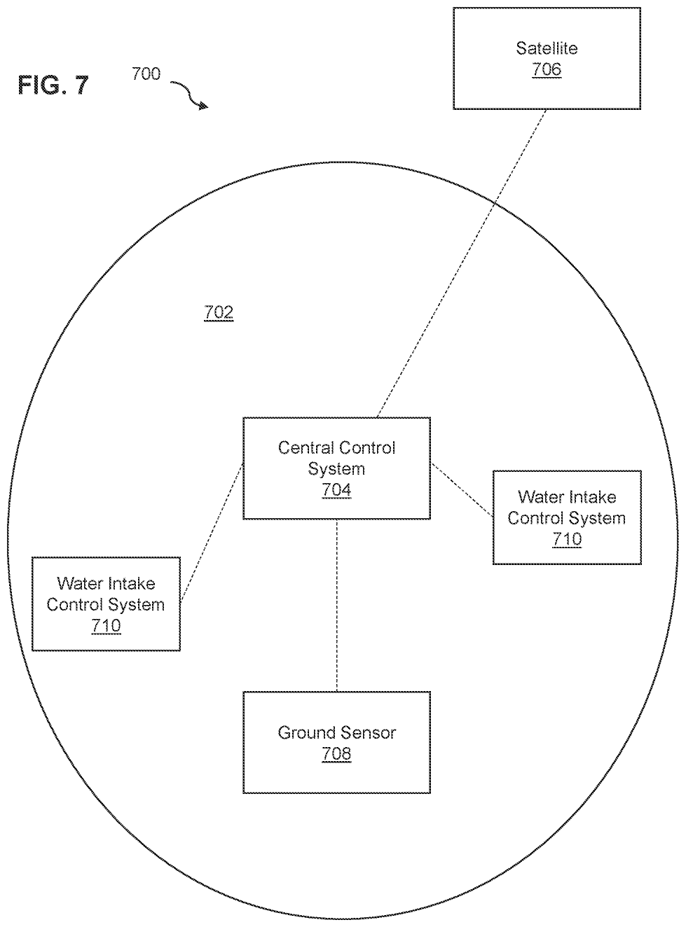

In some implementations, the control unit 510 receives signals from a remote source. For example, the control unit 510 may include a wireless receiver (e.g., a cellular receiver or a satellite receiver) that receives excess water measurement signals or control signals (e.g., to control the gate 506) from a remote source, e.g., a central control system, as described in further detail in reference to FIG. 7.

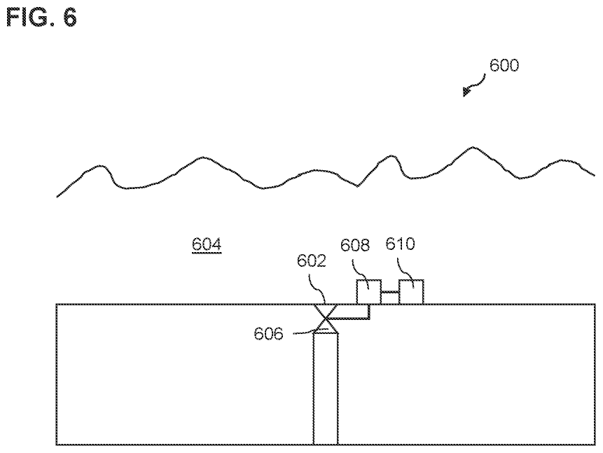

FIG. 6 shows another example of an ecosystem 600 in which an excess water drain 602 is disposed. In this example, the excess water drain 602 is disposed beneath a body of water 604, separated from the body of water 604 by a gate 606. The gate 606 is controlled by a control unit 608, e.g., to switch between open and closed positions and/or to switch across a continuous range of positions to regulate a rate of water flow from the body of water 604 into the excess water drain 602. Control of the gate 606 regulates an amount of water in the body of water 604 and, correspondingly, an amount of water in the ecosystem 600.

In some implementations, the control unit 608 controls the gate 606 wholly or partially based on water measurement signals from one or more local sensors 610, as described in reference to local sensor 514. In some implementations, the control unit 608 controls the gate 606 wholly or partially based on control signals from a remote source, e.g., a central control system.

The examples of FIGS. 5-6 represent examples of active water intake control systems. Components of these systems (e.g., the gates, control units, and sensors) may be powered by excess water flow itself (e.g., by the turbine generator of the energy generation system) and/or by a secondary power source of the energy generation system. For example, the components may be electrically connected to a photovoltaic system that provides power.

The examples of FIGS. 3-6 show excess water as flowing directly into the earth through conduits following entry into the excess water control drains. However, in some implementations, excess water is treated at the surface, e.g., to remove pollutants using a water filtration system at the surface. During this stage of excess water transport, the excess water may be actively moved through the system, e.g., by pumps.

FIG. 7 shows an example of an ecosystem-wide control system 700 in an ecosystem 702. The ecosystem 702 may be a local ecosystem, e.g., an area of several square miles. In some implementations, the ecosystem 702 is a large ecosystem spanning many miles, e.g., the Florida Everglades, California, or the Mississippi Delta.

A central control system 704 receives measurement signals from measurement units distributed throughout the ecosystem 702 and, in some implementations, outside the ecosystem 702. These measurement signals represent macroscopic environmental data, e.g., satellite data, weather data, and/or excess water measurement data over some or all of the ecosystem 702. Sources for these measurement signals may include, for example, ground sensors 708 (e.g., water level sensors disposed in or near bodies of water) and satellites 706.

The central control system 704 is configured to synthesize this macroscopic environmental data into a unified response policy in order to regulate excess water over the entire ecosystem 702, including, in some implementations, sending control signals to water intake control systems 710 distributed across the ecosystem. The control signals may be sent over one or more channels, including satellite transmission, cellular networks, and wired connections, based on corresponding signal transmission components of the central control system 704.

The water intake control systems 710 control water intake into one or more aquifers below the ecosystem 702, as described herein, thereby both generating electrical energy and regulating excess water levels in the ecosystem 702. The water intake control systems 710 may include one or more of the example implementations described in reference to FIGS. 3-6.

Because aquifers with excess capacity already exist under the earth, and because surface water can flow to these aquifers substantially by gravity alone, the systems and methods described herein may provide more efficient regulation of excess water (e.g., requiring less energy and/or other resources) than alternative systems that may rely on, for example, elaborate and large-scale pumping systems to transfer excess water from one location on earth's surface to another location on earth's surface (e.g., from inland to an ocean)

Besides generating electrical energy and controlling excess water levels in ecosystems, the systems described herein also can serve to replenish aquifers undergoing depletion. Excess water that might otherwise be flushed out to sea is instead captured by excess water drains and directed to aquifers that may serve as a useful water supply. When the excess water is sufficiently clean or suitably filtered, the excess water can be directed to potable aquifers used to supply water to human populations. The excess water also can be directed to deep aquifers to serve as a reserve against the depletion of near-surface aquifers.

Although configurations of the energy generation system 100 are shown in FIGS. 1-2, these are merely illustrative examples. In practice, the energy generation system 100 can have different arrangements of components, depending on the implementation. Furthermore, in practice, the energy generation system 100 can include more than one of some or all of the described components and/or exclude one or more of the described components.

For example, although a single conduit 106 is shown in FIGS. 1-2, in practice there may be any number of turbine generators 108 to generate electrical energy from flowing excess water. Furthermore, although the conduit 106 is shown as a channel having a single entrance aperture and a single exit aperture (e.g., a single channeled tube or pipe), other configurations are also possible.

As another example, although a single turbine generator 108 is shown in FIGS. 1-2, in practice there may be any number of turbine generators 108 to generate electrical energy from flowing excess water.

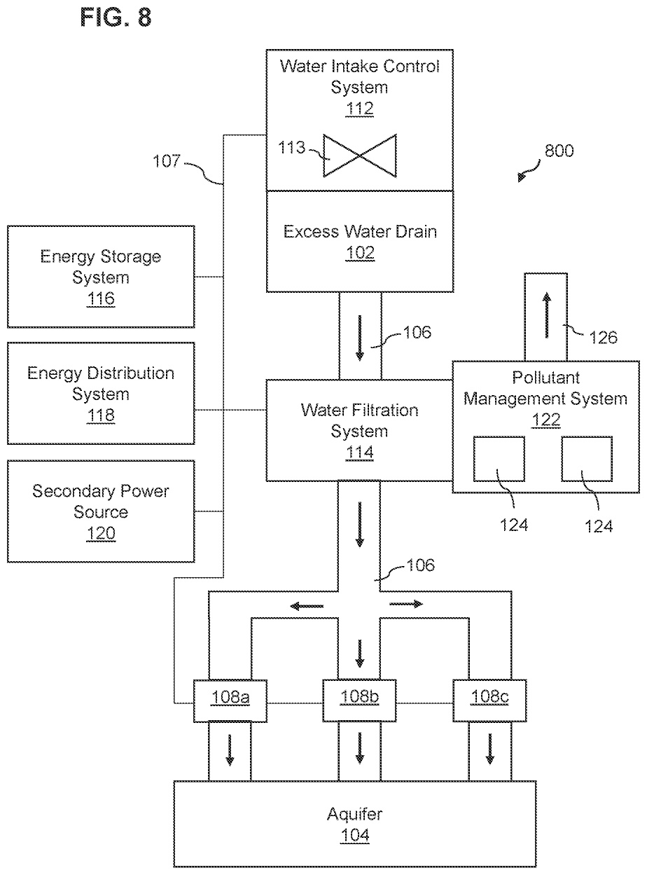

For instance, FIG. 8 shows another example energy generation system 800. In general, each of the components shown in FIG. 8 can operate similarly to those shown in FIG. 1. However, in this example, the conduit 106 extends through multiple turbine generators 108a, 108b, 108c (e.g., through a branching, multi-channeled configuration). This implementation allows the use of multiple turbine generators 108a, 108b, 108c. Such an implementation can be beneficial, for example, as it spreads the flow of excess water across multiple turbine generators such that the mechanical load across each of the turbine generators 108a, 108b, 108c is reduced. Moreover, this allows the energy generation system 800 to generate electricity more reliably (e.g., the energy generation system 800 can still generate electrical energy, even if some of the turbine generators 108a, 108b, 108c are damaged or disabled).

In some implementations, water can be directed selectively to particular turbine generators 108a, 108b, 108c (e.g., using valves positioned along the conduit 106c). This feature can be useful, for example, as it allows one or more of the turbine generators 108a, 108b, 108c to be serviced without interrupting the flow of excess water into the aquifer 104 and without interrupting the generation of electrical energy.

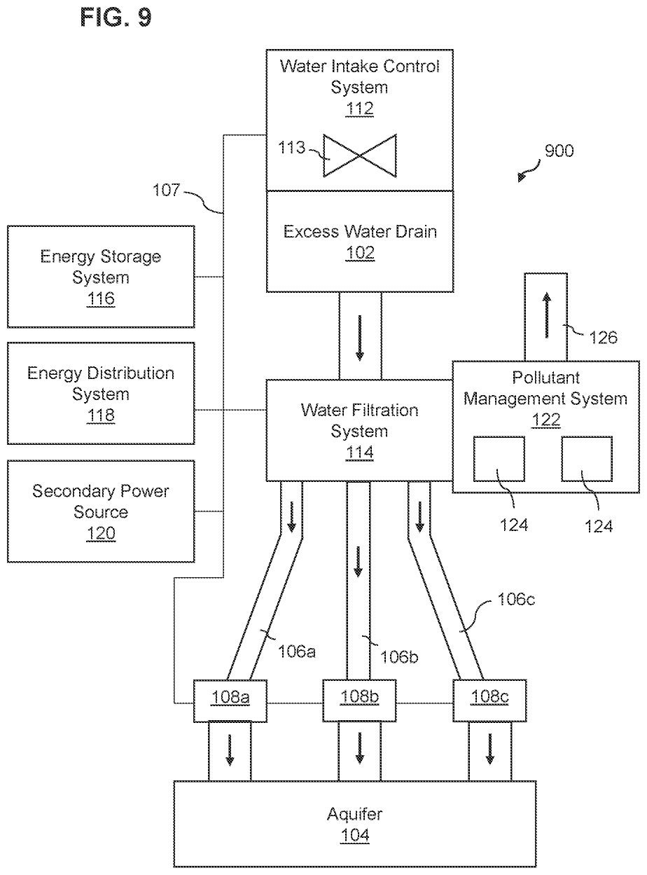

Another example energy generation system 900 is shown in FIG. 9. In general, each of the components shown in FIG. 9 can operate similarly to those shown in FIG. 1. However, in this example, the energy generation system 900 includes multiple conduits 106a, 106b, 106c that extend through multiple turbine generators 108a, 108b, 108c. This implementation allows the use of multiple turbine generators 108a, 108b, 108c simultaneously. As for the configuration shown in FIG. 8, this feature can be beneficial, for example, as it spreads the flow of excess water across multiple turbine generators such that the mechanical load across each of the turbine generators 108a, 108b, 108c is reduced. Moreover, this allows the energy generation system 100 to generate electricity more reliably (e.g., the energy generation system 900 can still generate electrical energy, even if some of the turbine generators 108a, 108b, 108c are damaged or disabled). In addition, the inclusion of multiple conduits 106a, 106b, 106c may make the system 900 more robust against blockages and mechanical failure because of the redundant multiple conduits 106a, 106b, 106c.

In some implementations, water can be directed selectively to particular turbine generators 108a, 108b, 108c (e.g., by selectively directing water into particular conduits 106a, 106b, 106c). This implementation can be useful, for example, as it allows one or more of the turbine generators 108a, 108b, 108c to be serviced without interrupting the flow of excess water into the aquifer 104 and without interrupting the generation of electrical energy.

In some examples, an energy generation system is used to replenish multiple aquifers. Aquifers may already be partially depleted by previous use and are therefore readily available to serve as a storage for excess water, as opposed to, for example, artificial subterranean storage tanks that would have to be specially built for this purpose.

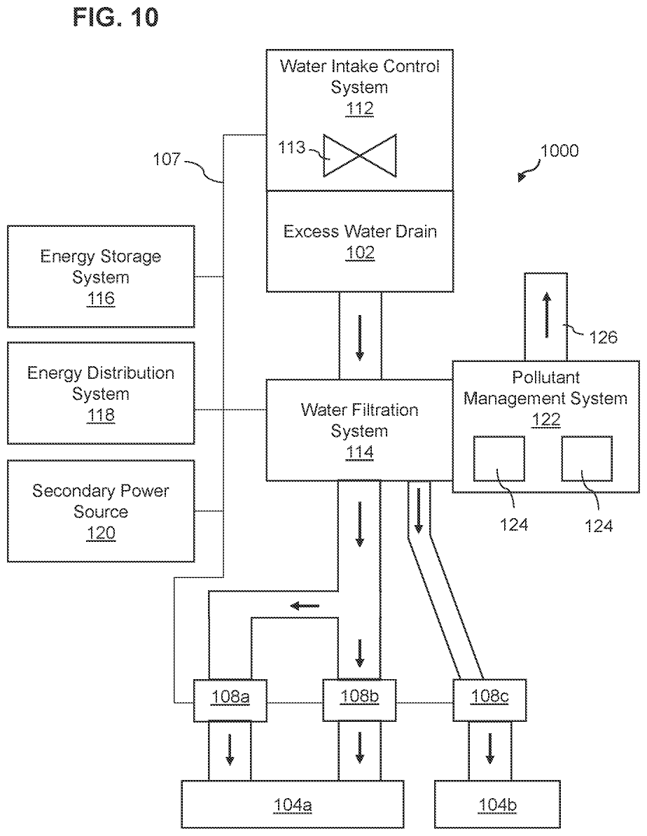

For example, FIG. 10 shows another example energy generation system 1000. In general, each of the components shown in FIG. 10 can operate similarly to those shown in FIG. 1. However, in this example, the energy generation system 1000 can selectively replenish multiple aquifers 104a, 104b, either simultaneously or sequentially (e.g., one at a time). Conduits 106a and 106b each extend through one or more turbine generators 108a, 108b, 108c.

Energy generation systems directing excess water to multiple aquifers can be used to replenish each aquifer independently. For example, the energy generation system 1000 may replenish both aquifers 104a, 104b simultaneously (e.g., when both aquifers are depleted). As another example, the energy generation system 1000 may replenish the aquifer 104a without flowing water to aquifer 104b (e.g., when only the aquifer 104a is depleted).

In practice, other configurations for energy generation systems are possible, depending on the implementation.

Various aspects and functional operations of the systems described in this specification, such as operations performed by water intake control systems, central control systems, control units, and sensors, may be implemented, at least in part, in digital electronic circuitry, a data processing apparatus, or in computer software, firmware, or hardware, including the structures disclosed in this specification and their structural equivalents, or in combinations of one or more of them. Likewise, various aspects and functional operations of the systems (e.g., operations described as being performed by water intake control systems, central control systems, control units, sensors, or other components) may be implemented as one or more computer program products, i.e., one or more modules of non-transient computer program instructions encoded on a non-transient computer readable medium for execution by, or to control the operation of, a data processing apparatus. The computer readable medium may be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both.

A number of implementations have been described. Nevertheless, it will be understood that various modifications may be made without departing from the spirit and scope of this disclosure. For example, features described above in connection with different embodiments may be combined in the same implementation. Further, some features described above may be omitted in some implementations. Accordingly, other implementations are within the scope of the claims.

1. An energy generation system comprising:
a water drain disposed at a first elevation;
an aquifer disposed at a second elevation lower than the first elevation;
a levee separating the water drain from a body of water;
a conduit in fluid communication with the water drain and the aquifer; and
a turbine generator disposed in the conduit, wherein the turbine generator is configured to convert kinetic energy of water flowing through the conduit from the water drain to the aquifer into electrical energy.

2. The energy generation system of claim 1, wherein the water drain is disposed in a first ecosystem, and
wherein the first elevation is higher than a high tide water level for the first ecosystem.

3. (canceled)

4. The energy generation system of claim 24, comprising:
a water intake control system configured to controllably adjust water flow into the water drain.

5. (canceled)

6. (canceled)

7. The energy generation system of claim 4, wherein the water intake control system comprises a local sensor arranged to measure an amount of water, and
wherein the water intake control system is configured to controllably adjust the water flow based on measurements from the local sensor.

8. The energy generation system of claim 4, comprising a central control system configured to perform operations comprising:
receiving macroscopic environment data of an ecosystem; and
based on the macroscopic environment data, transmitting control signals to a plurality of water intake control systems disposed in the ecosystem, including the water intake control system.

9. (canceled)

10. The energy generation system of claim 23, wherein the filtration system is powered, at least in part, by the electrical energy.

11. (canceled)

12. A method comprising:
collecting water in a water drain;
directing the water to an aquifer;
converting kinetic energy associated with the water as the water is directed to the aquifer into electrical energy; and
adjusting a configuration of a dam from a first configuration to a second configuration, wherein the first configuration blocks the water from flowing into the water drain, and wherein the second configuration allows the water to flow into the water drain.

13. (canceled)

14. (canceled)

15. The method of claim 12, comprising filtering pollutants out of the water subsequent to collecting the water in the water drain.

16. The method of claim 15, wherein filtering the pollutants out of the water comprises filtering the pollutants using a water filtration system powered at least partially by the electrical energy.

17. The method of claim 12, wherein directing the water to the aquifer comprises:
directing the water through a conduit in fluid communication with the water drain and the aquifer.

18. The method of claim 17, wherein converting the kinetic energy associated with the water as the water is directed to the aquifer into electrical energy comprises:
directing the water through a turbine generator disposed in the conduit.

19. The method of claim 12, wherein the water drain is disposed at a first elevation that is higher than a second elevation of the aquifer.

20. The method of claim 12, wherein directing the water to the aquifer comprises directing the water through a plurality of conduits in fluid communication with the water drain and the aquifer, and
wherein converting the kinetic energy associated with the water as the water is directed to the aquifer into electrical energy comprises directing the water through a plurality of turbine generators disposed in the plurality of conduits.

21. An energy generation system comprising:
a water drain disposed at a first elevation;
an aquifer disposed at a second elevation lower than the first elevation;
a conduit in fluid communication with the water drain and the aquifer;
a dam separating the water drain from a body of water;
a water intake control system configured to adjust the dam between a first configuration and a second configuration, wherein the first configuration blocks water from the body of water from flowing into the water drain, and wherein the second configuration allows the water from the body of water to flow into the water drain; and
a turbine generator disposed in the conduit, wherein the turbine generator is configured to convert kinetic energy of water flowing through the conduit from the water drain to the aquifer into electrical energy.

22. An energy generation system comprising:
a water drain disposed at a first elevation, wherein the water drain is disposed under a body of water;
an aquifer disposed at a second elevation lower than the first elevation;
a conduit in fluid communication with the water drain and the aquifer;
a gate adjustable between a first configuration and a second configuration;
a water intake control system configured to adjust the gate between the first configuration and the second configuration, wherein the first configuration blocks water from the body of water from flowing into the water drain, and wherein the second configuration allows the water from the body of water to flow into the water drain; and
a turbine generator disposed in the conduit, wherein the turbine generator is configured to convert kinetic energy of water flowing through the conduit from the water drain to the aquifer into electrical energy.

23. An energy generation system comprising:
a water drain disposed at a first elevation;
an aquifer disposed at a second elevation lower than the first elevation;
a conduit in fluid communication with the water drain and the aquifer;
a turbine generator disposed in the conduit, wherein the turbine generator is configured to convert kinetic energy of water flowing through the conduit from the water drain to the aquifer into electrical energy; and
a filtration system disposed in the conduit, the filtration system configured to filter one or more pollutants out of the water.

24. An energy generation system comprising:
a water drain disposed at a first elevation;
an aquifer disposed at a second elevation lower than the first elevation;
a conduit in fluid communication with the water drain and the aquifer, wherein the conduit comprises a pipe encasing a wellbore; and
a turbine generator disposed in the conduit, wherein the turbine generator is configured to convert kinetic energy of water flowing through the conduit from the water drain to the aquifer into electrical energy.

25. A method comprising:
collecting water in a water drain, wherein the water drain is disposed under a body of water;
directing the water to an aquifer;
converting kinetic energy associated with the water as the water is directed to the aquifer into electrical energy; and
adjusting a configuration of a gate from a first configuration to a second configuration, wherein the first configuration blocks water from the body of water from flowing into the water drain, and wherein the second configuration allows the water from the body of water to flow into the water drain.
